(19) United States
(12) Patent Application Publication
(10) Pub. No.: US 2005/0041808 A1
(43) Pub. Date: Feb. 24, 2005

(54) Method and apparatus for facilitating roaming between wireless domains

(75) Inventor: Haixiang He, Woburn, MA (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/646,024

(22) Filed: Aug. 22, 2003

(51) Int. Cl. H04K 1/00

(52) U.S. Cl. 380/248

(57) ABSTRACT

Roaming between domains may be facilitated by enabling a wireless user to obtain network access in a new foreign domain in connection with transmitting location registration information to a home domain, so that access to the wireless network may be established without engaging an AAA server in the domain. A mobile user, upon entering the domain, sends a registration message containing mobile user identification information and Mobile IP registration information. The message is intercepted by the wireless access provider servicing the foreign domain and forwarded to the wireless user's home domain. In the home domain, an AAA server evaluates the identification information, and the registration information is passed to the wireless user's home agent. The wireless access provider is notified of the result from the AAA server and the home agent starts to forward traffic for the wireless user to the foreign agent in the new foreign domain.

### CROSS REFERENCE TO RELATED APPLICATIONS

This application is related to U.S. Patent Application Ser. No. 10/608,601, Filed Jun. 27, 2003, entitled “METHOD AND APPARATUS FOR ESTABLISHING VIRTUAL PRIVATE NETWORK TUNNELS IN A WIRELESS NETWORK,” the content of which is hereby incorporated herein by reference.

### BACKGROUND OF THE INVENTION

1. Field of the Invention

The present invention relates to communication networks and, more particularly, to a method and apparatus for facilitating roaming between wireless networks.

2. Description of the Related Art

Data communication networks may include various computers, servers, nodes, routers, switches, hubs, proxies, and other devices coupled to and configured to pass data to one another. These devices will be referred to herein as “network devices.” Data is communicated through the data communication network by passing data packets (or data cells or segments) between the network devices by utilizing one or more communication links. A particular packet may be handled by multiple network devices and cross multiple communication links as it travels between its source and its destination over the network.

The various network devices on the communication network communicate with each other using predefined sets of rules, referred to herein as protocols. Different protocols are used to govern different aspects of the communication, such as how signals should be formed for transmission between network devices, various aspects of what the data packets should look like, and how packets should be handled or routed through the network by the network devices.

When a wireless user moves from one domain to another domain, such as from a home domain to a foreign domain or from one foreign domain to a second foreign domain (either of which will be referred to herein as entering a new foreign domain), and seeks to communicate on the wireless network instantiated in the new foreign domain, the wireless user must take several actions to maintain connectivity during the hand-over period.

FIG. 1 illustrates a conventional exchange between participants which may occur when a wireless user 10 moves into a new foreign domain. As shown in FIG. 1, conventionally, when a wireless user moves into a new foreign domain 14, the wireless user establishes layer 2 (link layer) connectivity on the wireless network instantiated in that domain and will seek to gain admittance to the wireless network by engaging an Authentication, Authorization, and Accounting (AAA) server 16 associated with a wireless access provider (WAP) 18. Engaging the AAA server may be direct or, as is more common, may be done under the direction of the wireless network. The process of engaging the AAA server enables the wireless access point to verify the user's identity and authorization to access the wireless network, and to establish accounting entries to enable the wireless access point to invoice the wireless user for admittance to the wireless network.

Once the wireless user has been granted admittance to the wireless network (part 1), the wireless user needs to inform its home domain of its new location information to ensure that packets destined for the wireless user are routed to the correct location. One protocol, referred to herein as Mobile IP, has been developed to enable a user to maintain a communication session when one or more of the IP addresses associated with the session changes. Specifically, utilizing the protocol specified by Mobile IP, the wireless user discovers the IP address (Care of Address: CoA) of a foreign agent (FA) 20 that will handle traffic on behalf of the wireless user in the foreign domain (part 2). The wireless user registers the CoA of the FA with its Home Agent (HA) 22 that has been designated as a communication agent on behalf of the wireless user in the home domain (part 3). As used herein, the term “home domain” will be used to refer to a domain containing the wireless user's home agent. Extensions to Mobile IP enable AAA information to be exchanged along with the Mobile IP registration information to enable the home agent to access a local AAA server to authenticate the identity of the mobile user. After the CoA/HoA (Care of IP Address/Home Agent IP Address) pair is registered with the HA (part 4), the HA will direct traffic for the wireless user to the FA (part 5), which sends the traffic to the wireless user (part 6). As illustrated in this embodiment, roaming between domains thus requires the wireless user to participate in at least two AAA exchanges.

Additionally, as discussed below, where the user is communicating over a Virtual Private Network (VPN), an additional AAA step may be required. A VPN may be formed by connecting two or more networks or network devices over a public network using encryption or other means, such as by attaching a unique label to traffic in a Multiprotocol Label Switching (MPLS) network, to secure the transmissions between the two or more networks or network devices. Using VPN tunnels over a public network such as the Internet enables a network having geographically separated components to be set up as a single autonomous network without requiring the network participants to lease dedicated lines through the network.

If the wireless user desires to participate on a VPN tunnel with a VPN host network, the wireless user initiates an additional protocol exchange with the VPN host network to set up a VPN tunnel to a VPN agent which may be the home agent or a VPN server (not shown in FIG. 1). Establishment of a VPN tunnel generally involves an exchange of additional information, such as a VPN ID, User ID and password, between the wireless user and the VPN host network. This information is used to authenticate the user and ascertain whether the user has authorization to access the network and/or participate in VPN communications with the VPN host network. If the AAA procedures are successful, a VPN tunnel is established between the wireless user and the host network.

Where a wireless user roams into a new foreign domain, there are therefore at least two and possibly three separate AAA sessions that must take place prior to establishing connectivity on the new domain during the hand-off session (one with the new foreign domain, a second with the HA, and possibly a third to access VPN services). Thus, a significant duplication of efforts may result where a wireless user roams between wireless domains. This duplication may result in a relatively long hand-off period which may be disruptive to time sensitive transmissions or delay sensitive transmissions. Where the methods taught in U.S. application 10/608,601 are used, it is possible to combine registration on the wireless network with registration to access VPN services. Even using this method, however, it is still necessary to engage in at least two AAA sessions (one to establish L2 connectivity on the foreign domain and to establish VPN services, and one in connection with exchanging Mobile IP registration information with the Home Agent) to maintain connectivity when a mobile user roams into a new foreign domain.

### SUMMARY OF THE INVENTION

The present invention overcomes these and other drawbacks by providing a method and apparatus to facilitate roaming between wireless domains by enabling a wireless user to obtain wireless network access on a new foreign domain in connection with transmitting location registration information to a home domain, so that admittance on the new foreign domain may be secured without having a pre-established relationship with the foreign domain. Roaming facilitated by embodiments of the invention includes roaming from a home network to a foreign domain and roaming between foreign domains.

For example, in one embodiment, a wireless user may access the wireless network in a new foreign domain, exchange location registration information with a home domain, and secure admission to the wireless network in the new foreign wireless domain without having an account on the new foreign domain or otherwise “gaining admittance” to the new foreign domain. As used herein, the phrase “gain admittance to the wireless network” will refer to determining by that wireless network whether the wireless user has authorization to participate in communications on the wireless network.

According to one embodiment of the invention, a mobile user, upon entering a new foreign domain, sends layer 2 (link layer) message on the wireless network in the new foreign domain, addressed to its Home Agent, and containing mobile user identification information and Mobile IP registration information, such as its Care of Address and Home Agent IP address. The layer 2 message is intercepted by the wireless access provider servicing the foreign domain. The wireless access provider adds a layer 3 (network layer) header, such as an IP header, and forwards the mobile IP registration information and mobile user identification information to the home domain in a AAA message. An AAA server associated with the home domain authenticates the identity of the mobile user, determines an authorization level associated with the mobile user, and establishes accounting entries associated with the mobile user. The Mobile IP registration information in the message is passed to the home agent in the home network. The wireless access provider is notified of the result from the AAA server and the home agent starts to forward traffic for the wireless user to the foreign agent in the new foreign domain.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a conventional wireless communications network configured to enable a wireless user to roam between wireless domains;

FIG. 2 is a functional block diagram of a wireless communications network configured to enable a wireless user to roam between wireless domains according to an embodiment of the invention;

FIG. 3 is a flow chart of a method for establishing a hand-off between wireless domains according to an embodiment of the invention;

FIG. 4 is a functional block diagram of a wireless communications network configured to enable a wireless user to roam between wireless domains and to enable the wireless user to join or establish a VPN tunnel with a VPN host network according to an embodiment of the invention;

FIG. 5 is a flow-chart of a method for establishing a hand-off between wireless domains and join or establishing a VPN tunnel between a wireless user and VPN host network according to an embodiment of the invention; and

FIG. 6 is a functional block diagram of a foreign agent according to an embodiment of the invention.

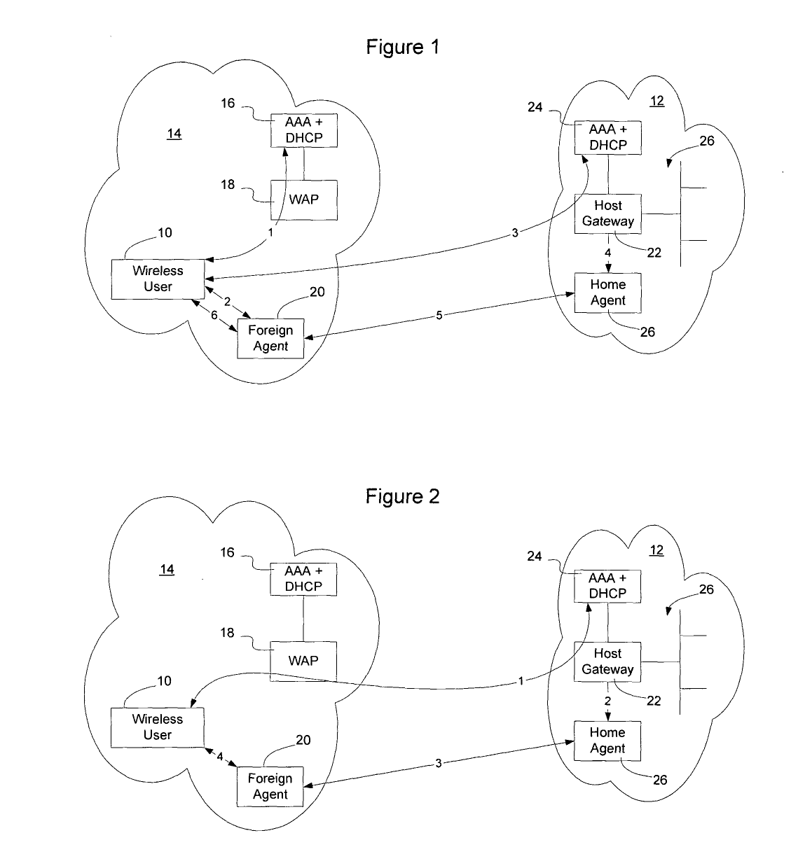

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

According to an embodiment of the invention, roaming between wireless networks is facilitated by enabling a wireless user to obtain wireless network access on a new foreign domain in connection with transmitting location registration information to a home domain, so that admittance on new foreign domain may be secured without having a pre-established relationship with the new foreign domain. Roaming facilitated by embodiments of the invention includes roaming from a home domain to a new foreign domain and roaming from one foreign domain to a new foreign domain.

For example, in one embodiment, a wireless user may access the wireless network in a new foreign domain, exchange location registration information with a home domain, and secure admission to the wireless network in the new foreign wireless domain without having an account on the new foreign domain or otherwise “gaining admittance” to the new foreign domain. As used herein, the phrase “gain admittance to the wireless network” will refer to determining by that wireless network whether the wireless user has authorization to participate in communications on the wireless network.

According to one embodiment of the invention, a mobile user, upon entering a new foreign domain, sends layer 2 (link layer) message on the wireless network in the new foreign domain, addressed to its Home Agent, and containing mobile user identification information and Mobile IP registration information, such as its Care of Address and Home Agent IP address. The layer 2 message is intercepted by the wireless access provider servicing the foreign domain. The wireless access provider adds a layer 3 (network layer) header, such as an IP header, and forwards the mobile IP registration information and mobile user identification information to the home domain in a AAA message. An AAA server associated with the home domain authenticates the identity of the mobile user, determines an authorization level associated with the mobile user, and establishes accounting entries associated with the mobile user. The Mobile IP registration information in the message is passed to the home agent in the home network. The wireless access provider is notified of the result from the AAA server and the home agent starts to forward traffic for the wireless user to the foreign agent in the new foreign domain.

Enabling the new foreign domain to rely on the result of the AAA server in the home domain allows the wireless user to participate in a single authorization and authentication session to establish connectivity within the new foreign domain. Where VPN services are to be provisioned from the home domain, the same AAA session may also be used by the wireless user to join or establish a VPN tunnel with the host network associated with the home domain. Additionally, since the wireless user does not need to gain admittance to the wireless network in the new foreign domain, the wireless user does not need to have an user account with the wireless network. Remuneration for wireless services provided on behalf of the wireless user may be provided by the home network or billed to the wireless user's account on the home network. Accordingly, a wireless user does not need to establish accounts with multiple wireless access providers but rather can establish a single account at the home network through which all billing matters can be handled. Where the home network is owned by a corporation and the wireless user is a corporate employee, this facilitates access to the corporate network by allowing the corporation to establish service level agreements with various wireless access providers on behalf of its employees.

FIG. 2 illustrates an embodiment of the invention in which a wireless user is able to obtain wireless services in a new foreign domain and exchange mobile IP routing information to its home domain with a reduced number of protocol exchanges.

As shown in FIG. 2, a wireless user 10, upon moving into a new foreign domain, needs to gain access to the wireless network to enable it to participate in wireless transmissions on the wireless network instantiated in the new foreign domain, and needs to exchange its contact information with its home domain to enable communications destined for the wireless user to be routed to the wireless user in the new network. As shown in FIG. 2, these actions may be combined by transmitting identification information and location information to a wireless access provider, and causing the wireless access provider to transmit the location information and identification information to the wireless user's home domain.

Specifically, as shown in FIG. 2, upon entering a foreign domain 14, the wireless user sends its identification information and known location information (home agent IP address) to a wireless access point 18. For facilitate explanation of the invention, the following description will assume that the location information is to be exchanged in accordance with the conventions set forth in the Mobile IP standard, the content of which is hereby incorporated herein by reference. Although in the illustrated embodiment the wireless access point 18 is shown as physically separate from the foreign agent 20, the invention is not limited to this embodiment as the wireless access point and foreign agent may be part of the same network device, co-located network devices, or completely separate network devices.

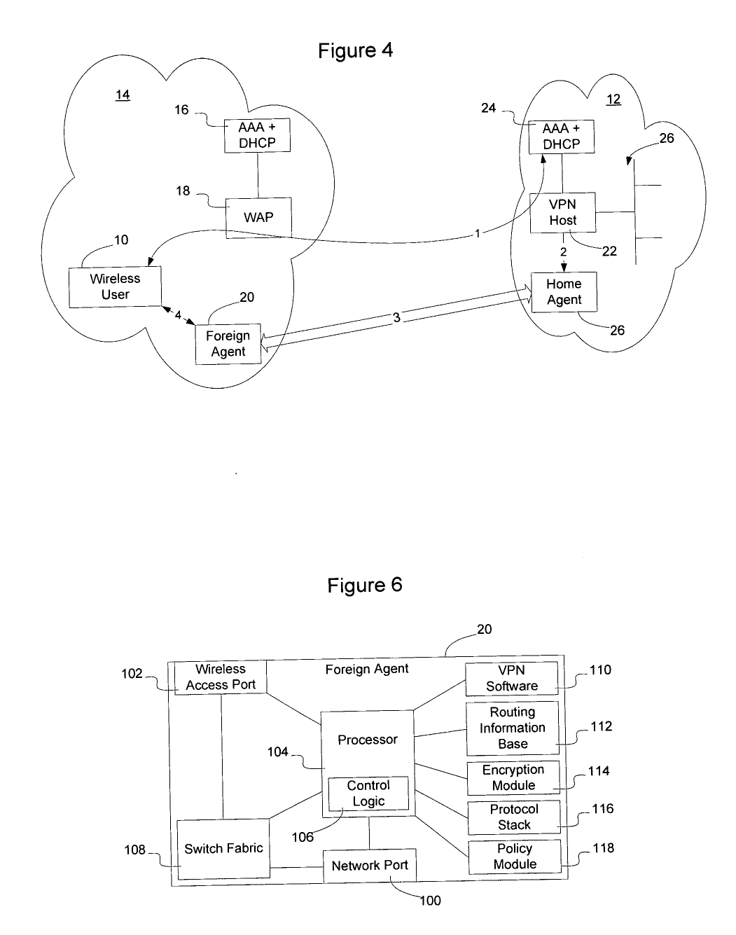

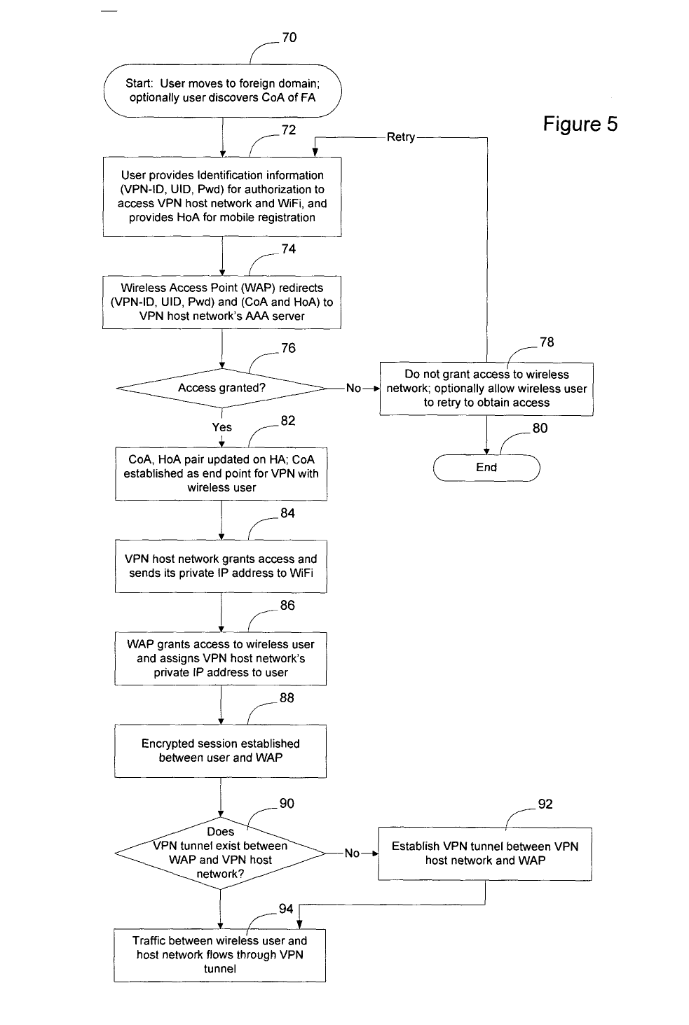

In this embodiment, the wireless user sends a layer 2 message containing the IP address of the home Agent (HoA), and identification information, such as an user ID and password, to the wireless access point 18. Where enhanced authentication is required the wireless user may be required to include a token or other indicia as proof of identity. The wireless access point inserts into the message an IP address (Care of Address: CoA) of a Foreign Agent 20 in the foreign domain that is to be designated to receive communications on behalf of the wireless user 10 (step 1). Optionally, the CoA may be determined by the wireless user and included in the layer 2 message sent to the wireless access point. Additionally, as discussed below in connection with FIGS. 4-5, a conceptual ID, such as a VPN ID may be included in the transmission to the home network 12.

In one embodiment, the location information and identification information is passed to the wireless access point using an 802.1x setup message or otherwise through a normal wireless authentication channel. In this embodiment, the location information and identification information is not encrypted and is thus visible to the wireless access point. Optionally, the identification information may be encrypted and not visible to the wireless access point. The setup message may be an Extensible Authentication Protocol (EAP) message, which is being adopted by the 802.1x standards that allows security authentication data to be passed between a RADIUS server (part of the VPN host network AAA server) and the access point and wireless client (user).

Upon reception by a host gateway 22 in the home domain, a local AAA server 24 is engaged to authenticate the identity of the wireless user, determine whether the wireless user is authorized to roam in the foreign network and optionally whether the wireless user is authorized to receive VPN services, and responds to the wireless access point with the result from the AAA server. The AAA server may also create accounting entities that may be utilized to track usage by the wireless user and to compensate the foreign domain for services provided to the wireless user.

A digital certificate may be used to authenticate the wireless network device being used by the wireless user. Additionally, a suitable user authentication protocol, such as Password Authentication Protocol (PAP) or Challenge Handshake Authentication Protocol (CHAP) may be utilized to authenticate the user of the network device. The invention is not limited in this regard as other forms of authentication may be utilized as well.

The IP address of the foreign agent (CoA) is passed to the home agent 26 and the CoA/HoA (HOA=IP address of the Home Agent) pair are updated on the home agent. Once the CoA/HoA pair are updated, the home agent is able to route communications to the wireless user in the foreign domain 20 via the CoA. The foreign agent 20 relays the communications to the wireless user over the wireless network in the foreign domain 14.

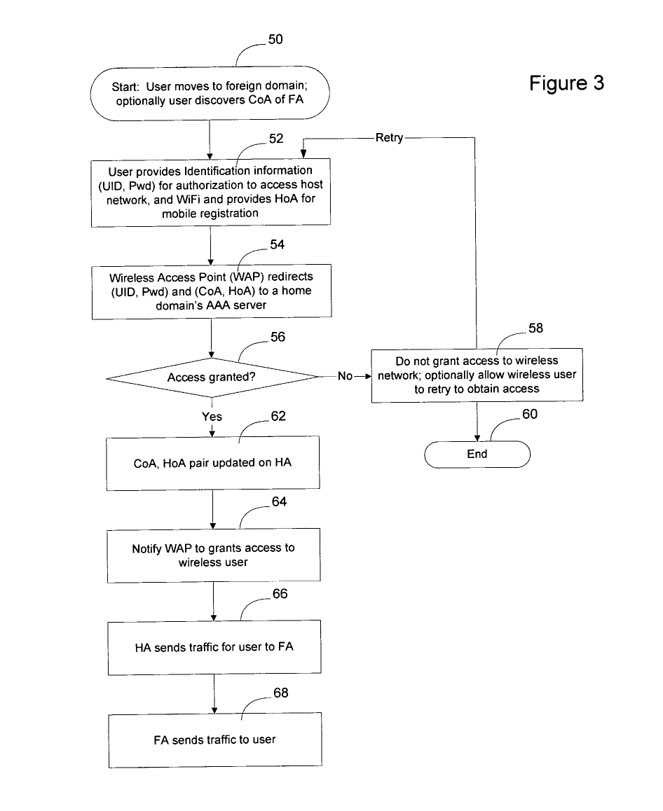

FIG. 3 illustrates one embodiment of software that may be utilized to implement embodiments of the invention. As shown in FIG. 3, when an user moves to a new foreign domain the user may discover the IP address (CoA) of a foreign agent in that domain (50). Determination of the foreign agent may be omitted where the IP address of a foreign agent to be assigned to a wireless user is known by a wireless access point associated with the foreign domain.

The user then issues a L2 message on the wireless network containing location information to enable the wireless user to register with its home agent in a home domain. The registration message, according to embodiments of the invention, includes identification information such as the users ID and password, to enable the wireless user to interface with an AAA server in the home domain (52).

The wireless access point directs the L2 message to the home network (54). In many instances, redirecting the L2 message to the home domain requires the wireless access point to prepend a L3 header, such as an IP header. The wireless access point, in one embodiment, may use the HoA as the “to” IP address, and may use the CoA as the “from” IP address. Alternative IP addresses may be used as well. Additionally, where the CoA has not been learned by the wireless user, it may be assigned by the wireless access provider and included in the L3 message to the home domain. Although the invention is described herein as having the wireless user issue a Layer 2 message, the invention is not limited to this embodiment as wireless networks may be developed that support layer 3 and above network messages as well.

The message is received at the home domain and passed to an AAA server associated with the home domain. The AAA server evaluates the wireless user's credentials (56) to ascertain if the user is authenticated and authorized to obtain access to the home agent and the wireless network in the foreign domain. Optionally, as discussed in greater detail below in connection with FIGS. 4 and 5, the AAA server may also evaluate whether the wireless user should be provided with access to resources, such as a VPN server, associated with the home network. The home network AAA server may also evaluate account information to ascertain whether the user should be allowed to access the home agent or wireless network (e.g. the user may have an outstanding balance on its account which would prevent the user from continuing to receive services without first paying off a portion of its account).

If the user does not receive a favorable outcome from the home domain's AAA server, the wireless user is notified that it has failed to obtain access to the wireless network and/or to the home agent as requested (58). At this point, the wireless user may be provided with an option to try again or the wireless session may terminate (60).

If the outcome from the AAA server is favorable, the CoA/HoA pair is updated on the home agent (62). The wireless access provider is notified (64) of the positive outcome and provided with any accounting entries necessary to enable it to keep track of and optionally to bill for usage of services by the wireless user. Communications between the wireless user are then routed from the home agent through the foreign agent, and on the reverse path from the foreign agent through the home agent (66). Traffic on the foreign wireless network may take place between the foreign agent and the wireless user using any conventional protocol (68).

FIG. 4 illustrates an embodiment of the invention in which communication with the home agent is to take place over a Virtual Private Network Tunnel. In the embodiment illustrated in FIG. 4, the messages passed from the wireless user to the wireless access provider are the same as in the previous embodiments, with the exception that the wireless user now includes a conceptual ID that may be used by the wireless access point or the home network to identify a VPN to which the wireless user would like to join. The identification information is used by the host network, together with the conceptual ID, to evaluate whether the wireless user should be allowed to join an existing VPN tunnel or create a new VPN tunnel.

Where a conceptual ID is included, the wireless access point 14 utilizes the VPN ID to identify an existing VPN tunnel to which the user would like to obtain access. If no tunnel exists, the public IP address of the VPN host network associated with the VPN ID is used by the wireless access point to connect to the appropriate VPN host network. The wireless access point 14 passes the VPN ID and other information to the foreign agent, and passes the conceptual ID, user ID (UID), user password (U Pwd), and IP address of the foreign agent, to the VPN host network.

Where VPN services are to be rendered to the wireless user 10, upon authenticating and authorizing the user, the VPN host network obtains a private IP address for the wireless user from its DHCP server. The private IP address is returned to the foreign agent 14 and an IP Sec tunnel or other VPN tunnel is established between the public VPN endpoint of the VPN host network 18 and the public VPN endpoint of the foreign agent 14. For a L3 tunnel, VPN endpoints will be IP addresses. The foreign agent then assigns the private IP address to the wireless user and establishes a secure L2 communications link with the wireless user using a wireless transmissions protocol. The secure L2 communications session may be formed using WEP, TKIP, or Advanced Encryption Standard (AES), a wireless replacement for DES and 3DES, or any other protocol configured to secure transmissions on a wireless local area network.

Once the VPN is established, if the wireless user 10 wishes to send data to the VPN host through the VPN tunnel, the wireless user 10 encrypts the data using the wireless LAN L2 encryption protocol in use on the wireless network and sends the data to the foreign agent 20. The foreign agent 20 removes the encryption in use on the wireless network and sends the data out over the VPN tunnel to the VPN host network. Where the VPN tunnel is formed using encryption, such as IPSec encryption, the foreign agent 20 encrypts the data using the agreed-upon encryption protocol prior to transmission to the VPN host network. Where the tunnel is formed using a MPLS encapsulation or other forms of encapsulation, the foreign agent 20 encapsulates the data prior to transmission to the VPN host network. Optionally, both encryption and encapsulation may be used and the invention is not limited to a particular implementation of the VPN tunnel between the VPN host network and the foreign agent 20.

The foreign agent 20 may support VPN tunnels with the VPN host networks by instantiating a virtual router to handle communications over the VPN tunnels, or may instantiate VPN routing and forwarding tables (VRF) pursuant to Internet Engineering Task Force (IETF) Request For Comments (RFC) 2547. The invention is not limited to any particular method of implementing the VPN on the wireless access point.

Transmissions from the VPN host network to the wireless user take place in a reverse manner. Specifically, the VPN host network will addrss traffic to the private IP address assigned to the wireless user, will cause the data to be transmitted over the VPN tunnel to be encrypted and/or encapsulated, and will transmit the data to the foreign agent 20. The foreign agent 20 removes the encryption/encapsulation and encrypts the data to be transmitted over the wireless network using WEP, TKIP, AES or whatever other encryption standard has been agreed upon by the wireless user and the foreign agent 20. The encrypted data is then transmitted over the wireless network to the wireless user.

The foreign agent 20, in one embodiment, interfaces between a L3 VPN tunnel formed between the foreign agent 20 and the VPN host network, and a L2 VPN tunnel between the foreign agent 20 and the wireless user. In this embodiment, the foreign agent 20 acts as a VPN gateway to the wireless network and functions to terminate L3 tunnels on behalf of wireless users. This is advantageous to the wireless user, as the wireless user is only required to have L2 encryption software to enable it to participate on a L3 VPN. This eliminates the need for the wireless user to instantiate a VPN client and reduces the requirements on the processor associated with the wireless user's network device since the network device will not be expected to participate as a VPN site on in an IP Sec or other VPN tunnel. Enabling the foreign agent to have an active role in the provision of VPN services is also advantageous in that it provides an additional revenue source for the owner of the wireless network.

The foreign agent 20 may be used to service multiple wireless users to enable the wireless users to access multiple VPN hosts. The foreign agent 20 may also be used to allow a wireless user to join VPN tunnels already established with a host network. Additional details of how a construct on a wireless network may enable a wireless user to participate in VPN tunnels with one or more host networks is set forth in greater detail in U.S. patent application Ser. No. 10/608,601, the content of which is hereby incorporated herein by reference.

FIG. 5 illustrates a flow chart of software that may be utilized in connection with an embodiment of the invention in which VPN services are to be rendered to the wireless user. As shown in FIG. 5, when a roaming wireless user enters a new foreign domain, and wishes to continue or establish a VPN tunnel through a home agent (72), the wireless user transmits a message containing identification information, location information, and conceptual ID to an entity on the wireless network in the new foreign domain. The identification information may include the user's ID number (UID), user password (Pwd), and other information that may be used to identify or verify the identity of the wireless user. The identification information in one embodiment is unrelated to the wireless network and is not sufficient to authenticate or obtain authorization to enable the user to access the wireless network. The location information, in this embodiment, may include the IP address of the Home Agent (HoA), and optionally may include the IP address of the Foreign Agent (CoA) if known by the wireless user. The conceptual ID may be a value, such as a VPN ID or the public IP address of the VPN host network VPN server, that enables a particular VPN or other private communication to be identified.

The wireless access point, upon receipt of the message, redirects the user ID and password to the VPN host network based on the VPN ID provided by the wireless user (74). The wireless access point also transmits the identification information to the home agent where the home agent is not associated with the VPN host network. For the remainder of this embodiment, it will be assumed that the VPN host network is associated with the home domain. The VPN host network evaluates the wireless user's credentials (76) to ascertain if the user is authenticated and authorized to obtain access to the VPN host network and/or the wireless network. The VPN host network may also evaluate account information to ascertain whether the user should be allowed to access the VPN host network or wireless network (e.g. the user may have an outstanding balance on its account which would prevent the user from continuing to receive services without first paying off a portion of its account). Where the home agent is associated with the VPN host network, the AAA evaluation performed on behalf of the VPN host network may be sufficient for the home agent as well. Where the home agent is not associated with the VPN host network, the home agent will cause an AAA server to perform authentication, authorization, and accounting services on behalf of the Mobile IP registration process.

If the user does not receive a favorable outcome from the VPN host network's AAA server, or from the home agent's AAA server, the wireless user is notified that it has failed to obtain access to the wireless network, home agent, and/or the VPN services requested (78). At this point, the wireless user may be provided with an option to try again or the wireless session may terminate (80).

If the access is granted to the wireless user, the CoA/HoA pair is updated on the home agent, and a VPN tunnel is established between the CoA of the foreign agent and the HoA of the home agent as discussed above in connection with FIG. 4 (82). In one embodiment, the VPN host network sends a private IP address to the foreign agent to be associated with the wireless user (84), and instructs the foreign agent to provide wireless services to the wireless user. The foreign agent grants access to the wireless user and assigns the private IP address to the wireless user (86). Obtaining IP addresses from the VPN host network DHCP server enables the wireless network to rely on the VPN host network for IP address allocation and maintenance.

The foreign agent initiates an encrypted communication session with the wireless user (88). The encrypted session may be initiated at this stage or initially when the wireless user first initiates communication on the wireless network. Establishing the encrypted session earlier in the process is advantageous in that the encrypted session allows for the secure transmission of identification information.

The foreign agent then ascertains whether the wireless user is seeking to join an already established VPN tunnel, or whether a new VPN tunnel needs to be established (90). If a VPN tunnel has already been established, the foreign agent relays all VPN traffic through the existing VPN tunnel to the VPN host network (92). If a VPN tunnel does not exist, a VPN tunnel (L2 or L3 tunnel) is established between the VPN host network and the wireless network (94). This new VPN tunnel is then used by the wireless network to relay all VPN traffic to the VPN host network (92).

In one embodiment of the invention, the VPN ID is evaluated by the wireless access point, and a foreign agent is assigned to the wireless user based on the evaluation. By preferentially assigning the wireless user to foreign agent that is already participating in a VPN tunnel that the wireless user seeks to join, it may be possible to minimize the number of VPN tunnels being supported by the wireless network.

One example of a foreign agent 20 according to an embodiment of the invention is illustrated in FIG. 6. The foreign agent, according to one embodiment of the invention, may be an aggregation switch serving to aggregate signals from many wireless network users and interface with higher bandwidth land-based communications networks, although the invention is not limited to this embodiment. As shown in FIG. 6, the foreign agent 20 in this embodiment includes network ports 100 configured to be connected to links in a communications network, and wireless access ports 102, such as one or more antennas, configured to interface with communications transmitted over at least a portion of the wireless spectrum.

The foreign agent may also include a processor 104 containing control logic 106 is configured to enable it to participate in communications as a foreign agent and optionally to participate in establishing VPN tunnels between wireless users and VPN host networks as described above in greater detail. A switch fabric 108 is configured to redirect packets received at network ports 100 and wireless access ports 102 to other network ports or wireless access ports 102. Functions performed on the switch fabric are directed by the processor in connection with VPN software 110 and informed by routing information base 112 containing routing information or other information requisite to enabling packets to be directed to appropriate wireless users and VPN tunnels.

Optionally, the foreign agent may also include various functional modules, such as an encryption module 114 configured to accelerate encryption of transmissions through the network ports 100 and/or the wireless access ports 102. A protocol stack 116 may be provided to enable the wireless access point to participate in protocol exchanges on the communications and wireless networks using known protocol conventions such as Mobile IP.

The foreign agent may also include a policy module 118 to enable the foreign agent to enforce a service level agreement with the wireless user to prevent the wireless user from obtaining bandwidth in excess of a predetermined level, and to attempt to ensure that the wireless user is provided with at least a minimum level of service. The invention is not limited in this regard, as the wireless access device may depend on other policy servers on the network to handle SLA enforcement.

The foreign agent may include additional or alternate components/processes configured to facilitate deployment of the functionality ascribed to it herein. The invention is thus not limited to a foreign agent or a system employing a foreign agent with only the enumerated components discussed herein, but rather extends to any foreign agent performing the functions described herein and as set out in the claims.

The control logic 106 of foreign agent 20 may be implemented as a set of program instructions that are stored in a computer readable memory within the network device and executed on a microprocessor, such as processor 104. However, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method for facilitating roaming between domains, comprising:
providing preliminary connectivity to a first wireless user on a first wireless network in a first wireless domain, said first wireless network not including a home agent associated with the first wireless user;
receiving identifying information and registration information associated with the first wireless user on the first wireless network;
sending the identifying information and registration information to a second domain containing the home agent associated with the first wireless user;
receiving an access result from the second domain; and
selectively granting access to the wireless user to enable the wireless user to gain admittance on the first wireless network based on the access result.

2. The method of claim 1, wherein the registration information comprises home agent identifying information associated with the home agent.

3. The method of claim 2, wherein the home agent identifying information is not encrypted when received by the first wireless network, and wherein the identifying information is encrypted when received by the first wireless network, and wherein the first wireless network does not decrypt the identifying information prior to transmitting the identifying information to the second network.

4. The method of claim 1, wherein the registration information comprises foreign agent identifying information associated with a foreign agent in the first wireless domain configured to receive communications on behalf of the wireless user.

5. The method of claim 1, wherein the registration information comprises home agent identifying information associated with the home agent, and foreign agent identifying information associated with a foreign agent in the first wireless domain configured to receive communications on behalf of the wireless user.

6. The method of claim 1, further comprising assigning a foreign agent in the first wireless domain configured to receive communications on behalf of the wireless user.

7. The method of claim 6, wherein sending further comprises sending foreign agent identifying information to the second domain.

8. The method of claim 7, wherein the home agent is configured to receive communications on behalf of the wireless user and forward the communications to the foreign agent based on the foreign agent identifying information.

9. The method of claim 1, wherein the identification information comprises an user ID and password.

10. The method of claim 9, wherein the identification information further comprises a token.

11. The method of claim 1, wherein receiving identifying information and registration information further comprises receiving conceptual information associated with a virtual private network (VPN).

12. The method of claim 11, further comprising providing access to the wireless user by the first wireless network to the VPN associated with the conceptual information.

13. A wireless access point, comprising:
control logic configured to:
provide preliminary connectivity to a first wireless user on a first wireless network in a first wireless domain, said first wireless network not including a home agent associated with the first wireless user;
receive identifying information and registration information associated with the first wireless user on the first wireless network;
send the identifying information and registration information to a second domain containing the home agent associated with the first wireless user;
receive an access result from the second domain; and
selectively grant access to the wireless user to enable the wireless user to gain admittance on the first wireless network based on the access result.

14. The wireless access point of claim 13, wherein the registration information comprises home agent identifying information associated with the home agent.

15. The wireless access point of claim 14, wherein the home agent identifying information is not encrypted when received by the first wireless network, and wherein the identifying information is encrypted when received by the first wireless network, and wherein the wireless access point is configured to not decrypt the identifying information prior to transmitting the identifying information to the second network.

16. The wireless access point of claim 13, wherein the registration information comprises foreign agent identifying information associated with a foreign agent in the first wireless domain configured to receive communications on behalf of the wireless user.

17. The wireless access point of claim 13, wherein the registration information comprises home agent identifying information associated with the home agent, and foreign agent identifying information associated with a foreign agent in the first wireless domain configured to receive communications on behalf of the wireless user.

18. The wireless access point of claim 13, wherein foreign agent identifying information identifies the wireless access point.

19. The wireless access point of claim 13, wherein the foreign agent identifying information identifies a network device in the first domain other than the wireless access point.
